(19) United States
(12) Patent Application Publication
(10) Pub. No.: US 2015/0036859 A1
(43) Pub. Date: Feb. 5, 2015

(54) EXPANDABLE ELECTRONIC DEVICE AND TRANSMISSION SYSTEM THEREOF

(71) Applicants: LITE-ON TECHNOLOGY CORPORATION, Taipei City (TW); LITE-ON ELECTRONICS (GUANGZHOU) LIMITED, Guangzhou (CN)

(72) Inventors: CHIH-WEN TU, NEW TAIPEI CITY (TW); YU-CHIH CHENG, NEW TAIPEI CITY (TW); YIU-CHIN LIU, TAIPEI CITY (TW); MENG-YUAN LIU, NEW TAIPEI CITY (TW); WEI-CHIH HSU, KAOHSIUNG CITY (TW)

(73) Assignees: LITE-ON TECHNOLOGY CORPORATION, Taipei City (TW); LITE-ON ELECTRONICS (GUANGZHOU) LIMITED, Guangzhou (CN)

(21) Appl. No.: 14/076,231

(22) Filed: Nov. 10, 2013

(30) Foreign Application Priority Data
Jul. 31, 2013 (CN) 201310329313.7

(51) Int. Cl. H04R 1/06

(52) U.S. Cl. CPC H04R 1/06
USPC 381/334

(57) ABSTRACT

A transmission system of expandable electronic device includes a first electronic device and a second electronic device. The first electronic device includes a first socket unit and a first processor, and the first socket includes a hall sensing circuit. The second electronic device includes a first plug unit and a second processor, and the first plug unit includes a first magnetic unit. The first processor couples to the first hall sensing circuit, the second processor couples to the first plug unit. By the plug unit inserts the first socket unit, the second electronic device couples to the first electronic device. When the first plug unit inserts the first socket unit, the first hall sensing circuit senses the first magnetic unit to generate a magnetic field sensing signal, and the first processor executes a first processing procedure according to magnetic field sensing signal.

### BACKGROUND

1. Technical Field

The present invention relates to an electronic device, in particular, to an expandable electronic device and a transmission system thereof.

2. Description of Related Art

In resent years, following the generation of the computer and information industry, a variety of new peripheral devices can electrically connect to the personal computer, notebook, or tablet easily. Besides, almost everybody has the smart mobile device, such as the smart phone. Thus, a method for connecting to the peripheral devices provides people have more wonderful life.

Therefore, many users can utilize the mobile device to play the favorite music or movies. For example, the user can listen to music individually through a connection between the earphone and the mobile device or the user can listen to music and share to others through the connection between the speaker and the mobile device.

However, for the higher peripheral device, its volume can easily cause the burden for users, such as the speaker. A better set of the speaker usually has many amplifiers to create the stereo, surround, or heavy bass effect. Nevertheless, in general life, the user cannot carry the speaker having so many amplifiers. The user can only carry the speaker having one amplifier, and then play the stereo sound through the simulate method, so that the user cannot have better sound quality in the outside.

### SUMMARY

According to one exemplary embodiment of the present invention, a transmission system of an expandable electronic device is provided. The transmission system comprises a first electronic device and a second electronic device. The first electronic device comprises a first socket unit and a first processor. The first socket unit has a first hall sensing circuit. The second electronic device comprises a first plug unit and a second processor. The first plug unit has a first magnetic unit. The first processor is coupled to the first hall sensing circuit. The second processor is coupled to the first plug unit. The first plug unit is used to insert into the first socket unit so that the second electronic device is electrically connected to the first electronic device. When the first plug unit is inserted into the first socket unit, the first magnetic unit is detected by the first hall sensing circuit so as to generate a first magnetic field sensing signal. The first processor executes a first processing procedure according to the first magnetic field sensing signal.

According to one exemplary embodiment of the present invention, an expandable electronic device is provided. The expandable electronic device comprises a socket unit and a processor. The socket unit has a hall sensing circuit. The processor is coupled to the socket unit. When the socket unit is inserted into a plug unit of another expandable electronic device, a first magnetic unit of the plug unit of another expandable electronic device is detected by the hall sensing circuit of the socket unit. The processor executes a processing procedure correspondingly.

According to one exemplary embodiment of the present invention, the expandable electronic device can connect to the magnetic unit of other electronic devices with the wired method through the hall sensing circuit, so as to identify whether the sort of other connected electronic devices are same to the expandable electronic device. When the sort of the other connected electronic devices are same to the expandable electronic device, all connected expandable electronic devices execute the signal processing by the cooperating method through the processor of each expandable electronic device. Through the above identification method, using one expandable electronic device can maintain original function and use many expandable electronic devices further to improve the original function. In other words, when the user carries one expandable electronic device only, the expandable electronic device can provide the original function. Furthermore, when the user carries many expandable electronic devices, the expandable electronic devices can be connected with each other and improve the original function through the expandable method.

To sum up, the hall sensing circuits of the expandable electronic device and transmission system thereof have several advantages. For example, the hall sensing circuit has higher sensitivity for the magnetic field, simpler structure, smaller volume, wider frequency response, larger variation of the output voltage, and longer service life, etc. In the situation that the expandable electronic device must usually be as the portable electronic device, the circuit design does not need to change the original circuit architecture substantially, so as to reach the required effect.

In order to further understand the techniques, means and effects of the present invention, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present invention.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain the principles of the present invention.

FIG. 1 shows a block diagram of a portable speaker according to an exemplary embodiment of the present invention.

FIG. 2 shows a diagram of a transmission system composed of several portable speakers according to the exemplary embodiment of the present invention.

FIG. 3 shows a flowchart of the identification method between several portable speakers according to the exemplary embodiment of the present invention.

FIG. 4A shows a diagram of the magnetic unit according to the exemplary embodiment of the present invention.

FIG. 4B shows a diagram of magnetic unit according to another exemplary embodiment of the present invention.

FIG. 5 shows a diagram of transmission composed of the portable speaker and the microphone according to the exemplary embodiment of the present invention.

FIG. 6 shows a flowchart of the identification method between the portable speaker and the microphone according to the exemplary embodiment of the present invention.

FIG. 7 shows a block diagram of a transmission system of an expandable electronic device according to the exemplary embodiment of the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

The exemplary embodiment provides an expandable electronic device and transmission system thereof. The expandable electronic device, for example, can be a portable speaker. The portable speaker is convenient and expandable, so that it can maintain the best effect while the user carries one or more speakers.

[An Exemplary Embodiment of the Portable Speaker]

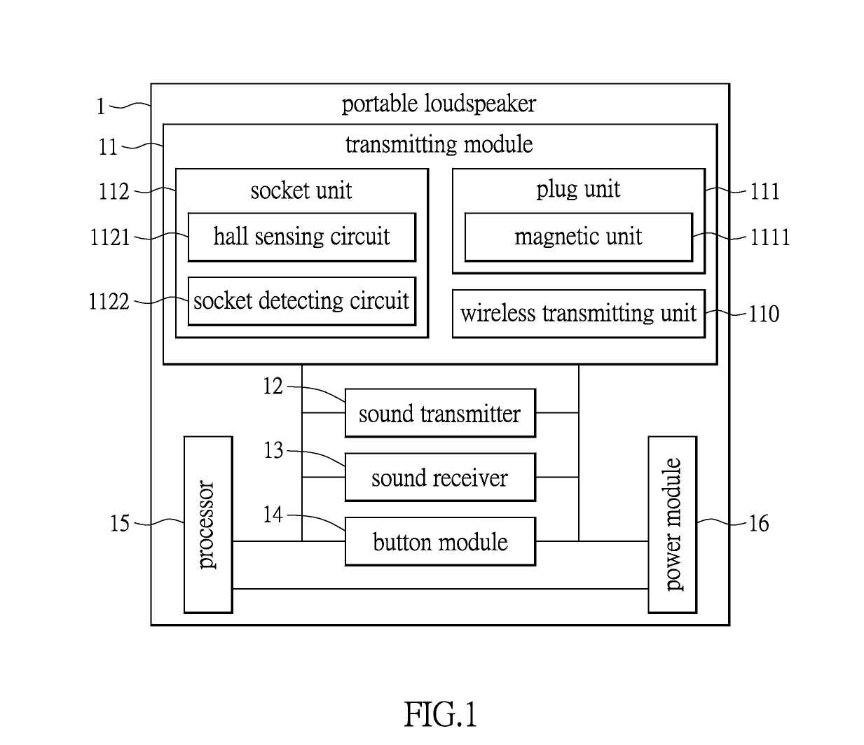

Please refer to FIG. 1. FIG. 1 describes a block diagram of a portable speaker according to an exemplary embodiment of the present invention. The portable speaker comprises a transmitting module 11, a sound transmitter 12, a sound receiver 13, a button module 14, a processor 15, and a power supply module 15. The transmitting module 11 comprises a wireless transmitting unit 110, a plug unit 111, and a socket unit 112. The socket unit 112 comprises a hall sensing circuit 1121 and a socket detecting circuit 1122. The plug unit 111 has a magnetic unit 1111. The transmitting module 11, the sound transmitter 12, the sound receiver 13, and the button module 14 are coupled to the processor 15. The transmitting module 11, the sound transmitter 12, the sound receiver 13, the button module 14, and the processor 15 are coupled to the power supply module 16.

The sound transmitter 12 is a transducer for transducing the electronic signal to the sound signal. Specifically, the sound transmitter 12 composes of the electromagnet, the coil, and the speaker diaphragm (not shown in FIG. 1). The sound transmitter 12 generates sound signal according to the frequency of current. For example, when current pass the coil and the electromagnetic field is generated accordingly, the sound transmitter 12 plays the frequency of C major scale by outputting the 256 Hz alternating current. When the coil and the speaker diaphragm are resonance to vibrate the surrounding air, the sound transmitter generates sound accordingly. The sound transmitter 12 can be an electromagnetic, a piezoelectric, an electrode, or a plasma speaker. The present invention is not limited thereto.

The sound receiver 13 is a transducer for transducing the sound signal to the electronic signal. Specifically, the sound receiver 13 composes of the coil, the diaphragm, and the permanent magnet (not shown in FIG. 1). For example, when the sound enters the sound receiver 13, the diaphragm suffers the pressure of the sound waves to generate vibration. Then the coil connected to the diaphragm starts to move in the magnetic field. According to Faraday's law and Lenz's law, the coil can generate the induced current. Then the induced current is transmitted to the processor 15 to execute the signal processing. The sound receiver 13 can be a moving coil, a capacitive, a micro-electromechanical, or a ribbon microphone. The present invention is not limited thereto.

The button module 14 has buttons which can control the function of the portable speaker 1. The buttons, for example, can be as the sound button, the power button, the play button, and stop button, etc. The present invention is not limited thereto. The power supply module 16 provides the power source for the portable speaker. Specifically, the power supply module 16 transduces the chemical energy to the electrical energy. The power supply module 16 can be a fuel cell, a Ni-Mh cell, or a solar cell, etc. The present invention is not limited thereto.

The processor 15 is the core operation of the portable speaker 1 and the processor 15 is used to process signals, data or instructions. Specifically, the instruction signals from other electronic devices which are received or transmitted by the transmitting module 11 can pass the processor 15 to execute the operation. Next, the processor 15 further controls the corresponding module according to the instruction signal to execute the corresponding action. For example, the user presses the button of the button module 14 to generate the signal for modulating sound. The button module 14 can transmit the signal for modulating sound to the processor 15 and then the processor 15 processes the signal. Afterward, the processor 15 transmits the control instruction corresponding to the signal for modulating sound to the sound transmitter 12, so as to modulate the sound level.

The transmitting module 11 comprises the wireless transmitting unit 110, the plug unit 111, and the socket unit 112. In the situation that the user only uses one portable speaker 1, the transmitting module 11 uses the wire or the wireless method through the wireless transmitting unit 110 or the plug unit 111 and the transmitting module 11 proceeds the signal transmission with other electronic devices. For example, the portable speaker 1 can connect to the smart phone or the tablet which prepare to play the video through wireless transmission (as WiFi signal or Bluetooth signal). Then the portable speaker 1 receives the audio signal of the smart phone or the tablet, and plays the video in the portable speaker 1. Besides, the user can insert the plug unit 111 into the sound socket of the smart phone or tablet through the wire method (as 2.5 mm socket, 3.5 mm socket, or 6.3 mm socket) and electrically connect to the smart phone or tablet, so that the portable speaker 1 can receive the audio signal of the smart phone or the tablet and then plays the audio signal through the sound transmitter 12.

It is worth to note that the plug unit of other portable speaker has the magnetic unit and the plug unit is inserted into the socket unit 112 of the portable speaker 1. The hall sensing circuit 1121 can generate a magnetic field sensing signal accordingly. For example, the magnetic field sensing signal has the information of the forward magnetic field and the reverse magnetic filed of the magnetic unit. The processor 15 can execute the processing procedure correspondingly according to the magnetic field sensing signal.

Specifically, when the other portable speaker and the portable speaker 1 are the same brand or the same model, the plug unit of the other portable speaker has the magnetic unit. At present, when the plug unit of the other portable speaker is inserted into the socket unit 112 of the portable speaker 1, the hall sensing circuit 1121 can generate the magnetic field sensing signal because the hall sensing circuit 1121 senses the magnetic field variation of the magnetic unit. Afterward, the processor 15 processes the audio signal according to the magnetic field sensing signal and generates another audio signal (e.g., the left sound channel signal) to the other portable speaker, so that the other portable speaker and the portable speaker 1 can play the audio signals respectively, such as the audio signals in the left and right sound channel.

On the contrary, when the other portable speaker and the portable speaker 1 are the different brand or the different model, the plug unit of the other portable speaker does not have the magnetic unit. At present, when the plug unit of the other portable speaker is inserted into the socket unit 112 of the portable speaker 1, the hall sensing circuit 1121 can not generate the magnetic field sensing signal because the plug unit of the other portable speaker does not have the magnetic unit and does not have the magnetic field variation. Thus, the processor 15 just transmits the audio signal to the other portable speaker, so that the other portable speaker and the portable speaker 1 are play the audio signal at the same time.

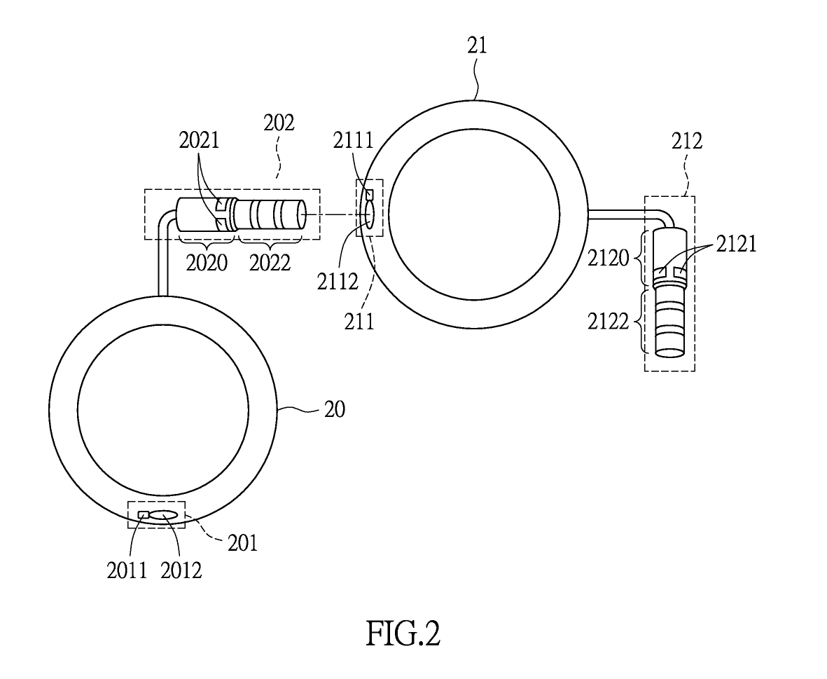

Next, please refer to FIG. 2. FIG. 2 describes a diagram of a transmission system composed of several portable speakers according to the exemplary embodiment of the present invention. As shown in FIG. 2, the transmission system is composed of two portable speakers 20, 21. The portable speaker 20 has a socket unit 201 and a plug unit 202. The portable speaker 21 has a socket unit 211 and a plug unit 212. The socket unit 201 has a hall sensing circuit 2011 and socket 2012. The socket unit 211 has a hall sensing circuit 2111 and a socket 2112. The plug unit 202 has a magnetic unit 2021. The plug unit 212 has a magnetic unit 2121.

In the situation that the user uses several portable speakers 1, for example, the portable speakers 20, 21 as shown in FIG. 2. The socket unit 211 of the portable speaker 21 is further connected to the portable speaker 20, so that the user can further use many portable speakers 20, 21 and play the audio signal in the portable speakers 20, 21 at the same time. It is worth to note that only shows two portable speakers 20, 21 in FIG. 2. Actually, it may use three or more portable speakers in another exemplary embodiment. The present invention is not limited thereto.

Please refer to FIG. 1 and FIG. 2. The socket unit 112 further has a socket detecting circuit 1122 and a hall sensing circuit 1121. The socket detecting circuit 1122 is used to detect whether the socket is inserted into other electronic devices. For example, when the socket detecting circuit (not shown in FIG. 2) of the portable speaker 21 can determine the socket 2112 is inserted into the plug unit 202 of the portable speaker 20, and the socket detecting circuit further starts the following determination procedure. When the socket 2112 of the portable speaker 21 is not inserted into the socket unit 202 of the portable speaker 20, the portable speaker 21 maintains its original action.

In the exemplary embodiment of the present invention, the hall sensing circuit 1121 of FIG. 1 is disposed near the socket. As shown in FIG. 2, the hall sensing circuit 2011 is disposed near the socket 2012. The hall sensing circuit 2111 is disposed near the socket 2112. The hall sensing circuit is a magnetic sensor according to the Hall-effect, which is used to detect the magnetic field variation and outputs the magnetic field sensing signal. For example, when the plug unit 202 of the portable speaker 20 is inserted into the socket 2112 of the portable speaker 21, the magnetic unit 2021 of the plug unit 202 can close to the hall sensing circuit 2111 of the portable speaker 21. At present, the hall sensing circuit 2111 near the socket 2112 can detect the magnetic field variation and transduces the magnetic field variation to the magnetic field sensing signal. Then the hall sensing circuit 2111 provides a sensing mode corresponding to the magnetic field sensing signal to the processor and executes the following processing procedure.

As shown in FIG. 2, the magnetic unit 2021 of the plug unit 202 is disposed on an insulating part of the plug unit 202. When a conducting part 2022 is inserted into the socket 2112 of the socket unit 211 of the portable speaker 21, the magnetic unit 2021 can close to the hall sensing circuit 2111 of the socket 2112, and the magnetic unit 2021 can provide the magnetic field variation, so that the hall sensing circuit 2111 can detect the magnetic field variation and can generate the magnetic field sensing signal accordingly.

It is worth to note that the transmission system of FIG. 2 can further connect to the other portable speaker. When the plug unit (not shown in FIG. 2) of the other portable speaker is inserted into the socket 2012 of the portable speaker 20, the hall sensing circuit 2011 of the portable speaker 20 can detect the magnetic unit of the plug unit. At present, the processor of the portable speaker 20 executes the corresponding processing procedure and transmits a result corresponding to the processing procedure to the processor of the portable speaker 21. On the other hand, the processor of the portable speaker 20 can process the result which is determined by the hall sensing circuit 2011 and then provides the result of the processing procedure to the processor of the portable speaker 21.

Next, the processor of the portable speaker 21 further executes the processing procedure of the processor of the portable speaker 21 according to the result of the processing procedure by the processor of the portable speaker 20 executing. The processor of the portable speaker 21 generates a result after executing the processing procedure and then provides to other portable speaker. For example, three portable speakers have same brand or same model. When three portable speakers are connected with each other, the first portable speaker receives, for example, the audio signal of the smart phone and processes the audio signal, so as to generate the audio signals of the left and right sound channel and heavy bass. Then the first portable speaker plays the left sound channel and transmits the right sound channel and heavy bass to the second portable speaker. The second portable speaker plays the right sound channel and transmits the heavy bass to the third portable speaker. The third portable speaker plays the heavy bass. The exemplary invention can also connect four or more portable speakers with each other and the operation of the above combination is similar to the three portable speaker of the above exemplary embodiment, the present invention is not limited thereto.

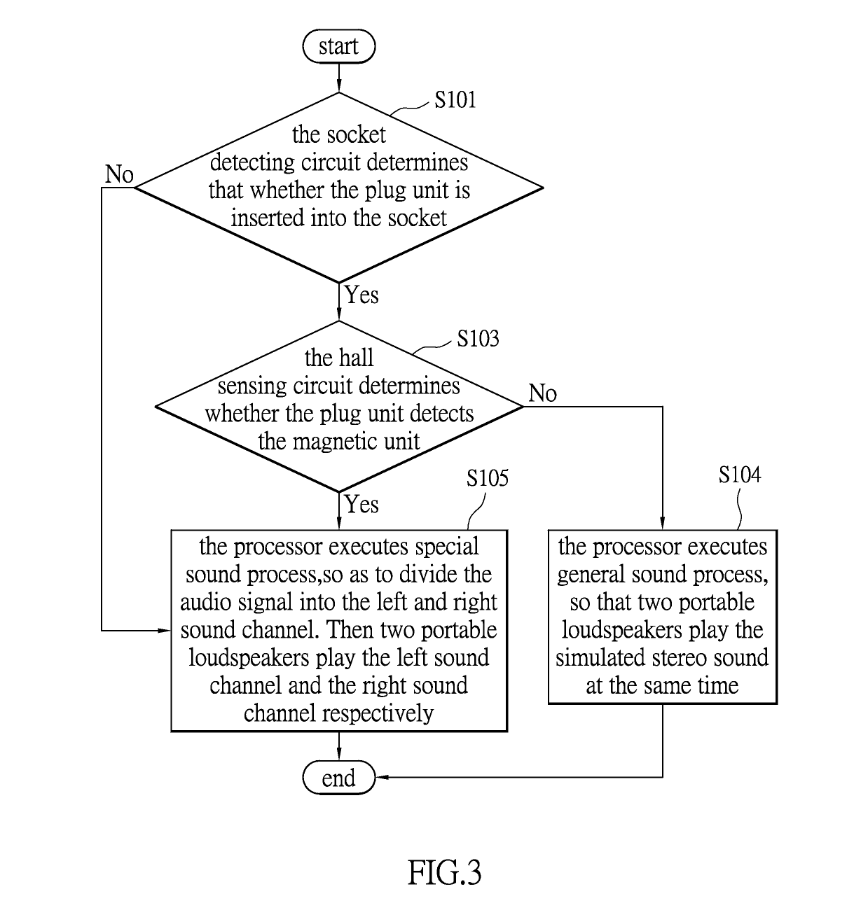

Please refer to FIG. 3. FIG. 3 describes a flowchart of the identification method between several portable speakers according to the exemplary embodiment of the present invention. FIG. 3 further describes the operation procedure while two portable speakers are connected with each other in FIG. 2. In step S101, the socket detecting circuit determines whether the plug unit is inserted into the socket. In the step S103, the hall sensing circuit determines whether the plug unit detects the magnetic unit. In the step S104, when the hall sensing circuit does not detect the magnetic unit, the processor executes general sound process, so that two portable speakers play the simulated stereo sound at the same time. In the S105, when the hall sensing circuit detects the magnetic unit, the processor executes special sound process, so as to divide the audio signal into the left and right sound channel. Then two portable speakers play the left sound channel and the right sound channel respectively.

Please refer to FIG. 2, In the S101, when the plug unit 202 of the portable speaker 20 is inserted into the socket 2112 of the socket unit 211 of the portable speaker 21, the socket detecting circuit (not shown in FIG. 2) of the socket unit 211 of the portable speaker 21 can determine whether the inserted plug conforms to the specification. For example, the socket 2112 of the socket unit 211 of the portable speaker 21 is 3.5 mm socket. When the plug unit 202 of the portable speaker 20 is inserted into the socket 2112, the socket detecting circuit of the socket unit 211 can determine whether the plug unit 202 is 3.5 mm plug. If yes, processing the next step.

In the step S103, after determining the plug unit 202 conforms to the specification, the hall sensing circuit 2111 detects whether the inserted plug unit 202 has the magnetic unit 2021. When the hall sensing circuit 2111 does not detect the plug unit 202 having the magnetic unit 2021, the step S104 is executed. When the hall sensing circuit 2111 detects that the plug unit 202 having the magnetic unit 2021, the step S105 is executed.

In the step S104, the hall sensing circuit 2111 does not detect the magnetic unit 2021. It means the connected speaker is not the portable speaker of the present invention (i.e. the portable speaker having general function). Thus, the hall sensing circuit 2111 outputs an identify signal to notify the processor of the portable speaker 21 that the connected speaker is not the portable speaker. The portable speaker 21 and the connected speaker cannot output the audio signal by the cooperation method. At present, the processor of the portable speaker 21 executes general sound process, so that the portable speaker 21 and the connected speaker play the simulated stereo sound at the same time.

In the step S105, the hall sensing circuit 2111 detects the plug unit 202 having the magnetic unit 2021. It means the connected speaker is the portable speaker of the present invention (i.e. the connected speaker having cooperation function). Thus, the hall sensing circuit 2111 outputs the identify signal to notify the processor of the portable speaker 21 that the connected speaker is the portable speaker 20. Then the portable speaker 21 and the portable speaker 20 can output the audio signal by the cooperation method. At present, the processor of the portable speaker 21 executes special sound process, so as to divide the audio signal into the left and right sound channel. Then two portable speakers play the left sound channel and the right sound channel respectively, so that two portable speakers form a real stereo sound.

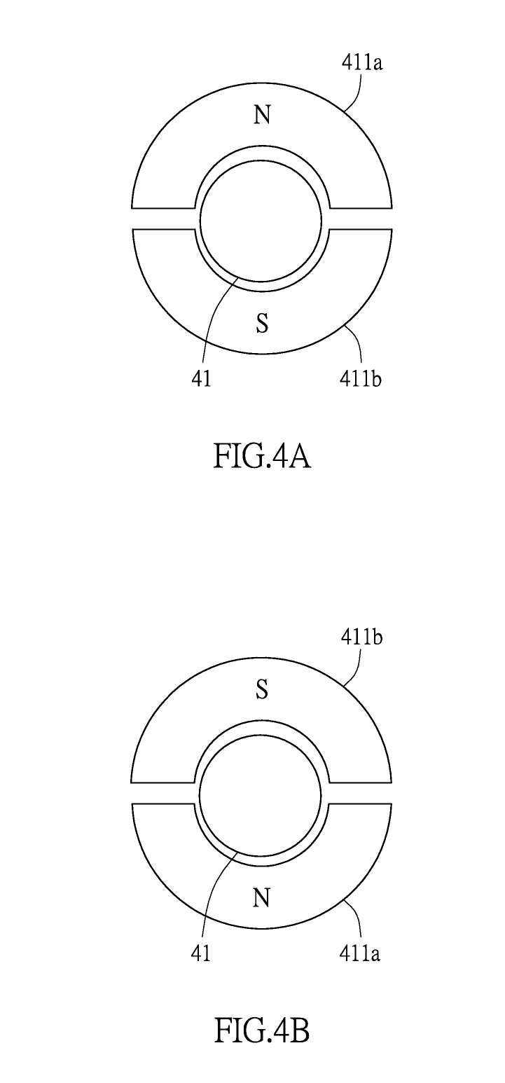

Please refer to FIG. 2, FIG. 4A, and FIG. 4B. FIG. 4A describes a diagram of the magnetic unit according to the exemplary embodiment of the present invention. FIG. 4B describes a diagram of magnetic unit according to another exemplary embodiment of the present invention. In the exemplary embodiment, the magnetic unit 2021 is a magnetic ring (i.e. the magnetic ring is composed of N pole part 411a and S pole part 411b in FIG. 4A and FIG. 4B). The middle part is the conducting part 41 (i.e. the conducting part 2022) of the plug unit 202. The magnetic unit 2021 can also be magnetic strip or other forms of the magnets. The present invention is not limited thereto. FIG. 4A and FIG. 4B describes the sectional view of the plug unit 202 and 212 of FIG. 2. Specifically, the magnetic unit 2021 and 2121 (i.e. the magnetic ring) can be divided into N pole part 411a and S pole part 411b. In the exemplary embodiment of the present invention, the hall sensing circuit 2011 and 2111 can define different sensing mode through the polar direction of the magnetic unit 2021 and 2121 respectively.

For example, FIG. 4A can be preset as a magnetic direction of a first sensing mode in the magnetic sensing circuit 2011 or 2111. The first sensing mode processes the audio signal which the smart phone or tablet receives. Then the left and right sound channel signals are generated accordingly and are outputted to the portable speakers 20, 21 respectively. FIG. 4B can be preset as a magnetic direction of a second sensing mode of the magnetic sensing circuit 2011 or 2111. The second sensing mode processes that audio signal are received from the smart phone or tablet. Then the heavy bass signal is generated accordingly and is outputted to the portable speakers 20, 21. When the plug unit 202 of FIG. 2 is inserted into the socket 2112, the hall sensing circuit 2111 can detect the magnetic unit 2021 of the plug unit 202. When the hall sensing circuit 2111 detects the forward magnetic field which the magnetic unit 2021 provides (as the magnetic direction of FIG. 4A) and the hall sensing circuit 2111 distinguishes the forward magnetic field as the first sensing mode. The hall sensing circuit 2111 transmits the identify signal of the first sensing mode to the processor of the portable speaker 21. The processor of the portable speaker 21 further executes the processing procedure correspondingly (i.e. processing the audio signal). Then the left and right sound channel signals are generated and outputted to the portable speakers 20, 21 respectively, so as to generate the stereo sound effect. When the hall sensing circuit 2111 detects the reverse magnetic field which the magnetic unit 2021 provides (as the magnetic direction of FIG. 4B) and the hall sensing circuit 2111 distinguishes the reverse magnetic field as the second sensing mode. The hall sensing circuit 2111 transmits the identify signal of the second sensing mode to the processor of the portable speaker 21. The processor of the portable speaker 21 further executes the processing procedure correspondingly (i.e. processing the audio signal). Then the heavy bass effect is generated. In the exemplary embodiment, the first sensing mode and the second sensing mode are exemplarily described. The hall sensing circuit can have other magnetic directions as the different sensing mode, and the present invention is not limited thereto.

[An Exemplary Embodiment of a Transmission System of a Portable Speaker and a Special Microphone]

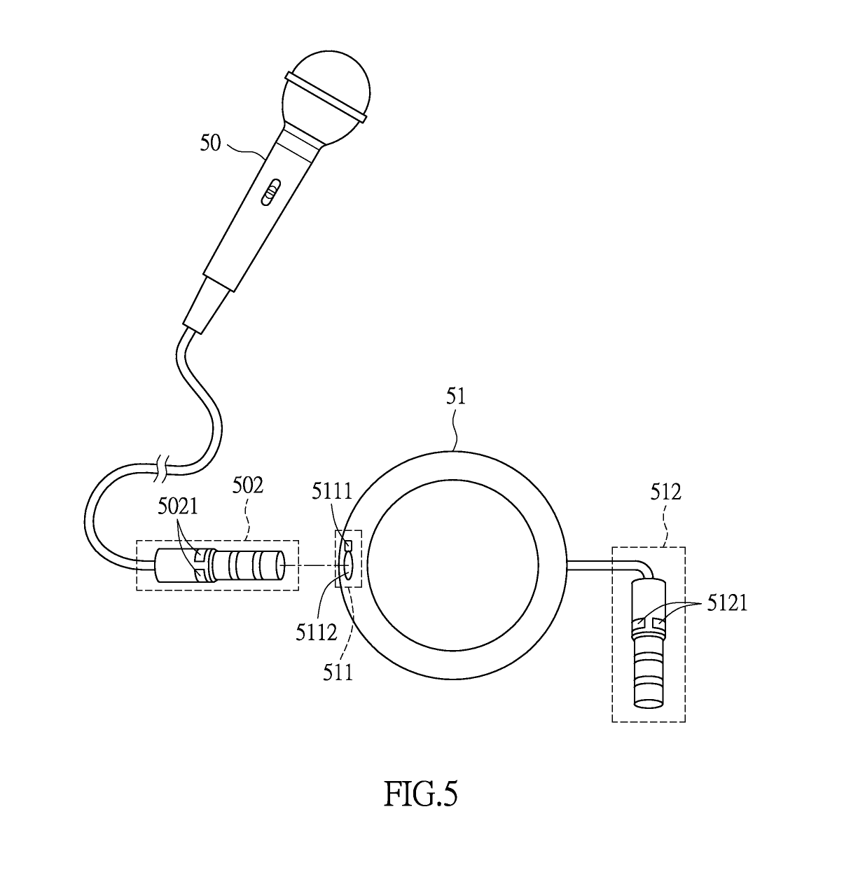

Please refer to FIG. 5. FIG. 5 describes a diagram of transmission composed of the portable speaker and the microphone according to the exemplary embodiment of the present invention. FIG. 5 shows a portable speaker 51 and a special microphone 50. The portable speaker 51 has a socket unit 511 and a plug unit 512. The socket unit 511 has a hall sensing circuit 5111 and a socket 5112. The plug unit 512 has a magnetic unit 5121. The special microphone 50 has a plug unit 502. The plug unit 502 has a magnetic unit 5021.

In the exemplary embodiment, in the situation that the portable speaker 51 is connected to the smart phone or tablet and receive the audio signal accordingly, the portable speaker 51 can connect other audio devices, such as the microphone 50 shown in FIG. 5.

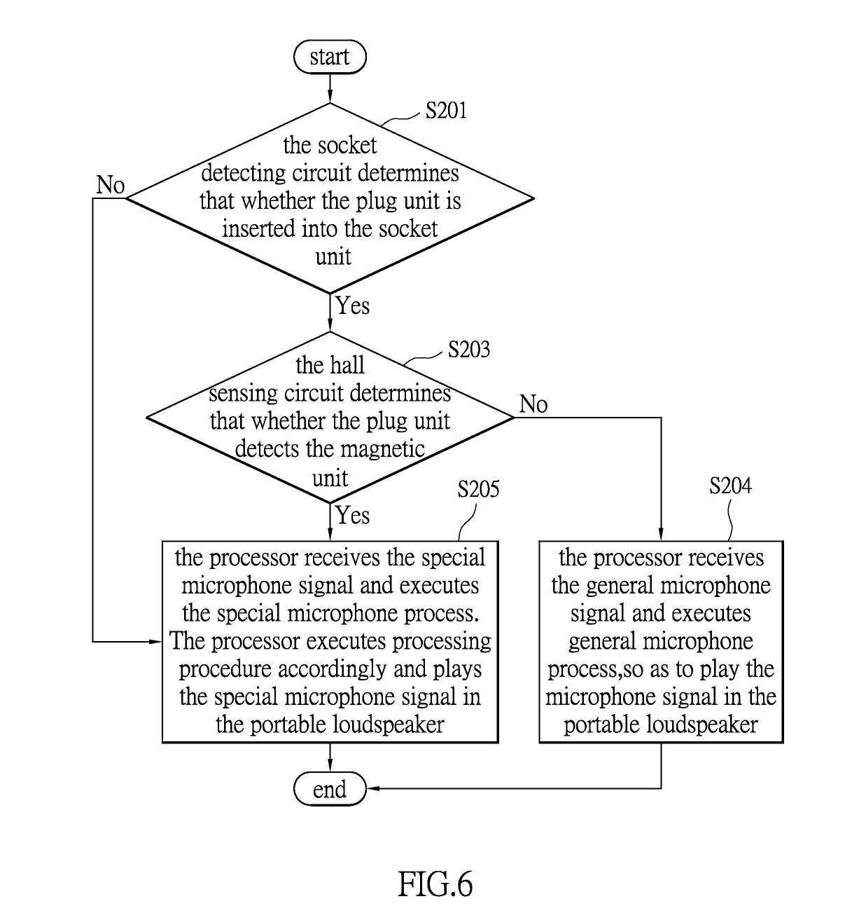

Please refer to FIG. 6. FIG. 6 describes a flowchart of the identification method between the portable speaker and the microphone according to the exemplary embodiment of the present invention. FIG. 6 further describes the operation procedure while the portable speaker 51 and the microphone are connected with each other in FIG. 5. In the step S201, the socket detecting circuit determines whether the plug unit is inserted into the socket. In the step S203, the hall sensing circuit determines whether the plug unit detects the magnetic unit. In the step S204, when the hall sensing circuit does not detect the magnetic unit, the processor executes general microphone process (i.e. receives general microphone signal), so as to play the microphone signal in the portable speaker. In the step S205, when the hall sensing circuit detects the magnetic unit, the processor executes special microphone process (i.e. receives special microphone signal and then executes the processing procedure), so as to play the microphone signal in the portable speaker.

Please refer to FIG. 5, in the step S201, When the plug unit 502 of the microphone 50 is inserted into the socket 5112 of the socket unit 511 of the portable speaker 51, the socket detecting circuit (not shown in FIG. 5) of the socket unit 511 of the portable speaker 51 can determine whether the inserted plug conforms to the specification. For example, the socket 5112 of the socket unit 511 of the portable speaker 51 is 3.5 mm socket. When the plug unit 502 of the portable speaker 50 is inserted into the socket 5112, the socket detecting circuit of the socket unit 511 can determine whether the plug unit 502 of the microphone 50 is 3.5 mm plug. If yes, processing the next step.

In the step S203, after determining the plug unit 202 conforms to the specification, the hall sensing circuit 5111 is further executed. Afterward, the hall sensing circuit 5111 detects whether the inserted plug unit 502 has the magnetic unit 5021. When the hall sensing circuit 5111 does not detect the plug unit 502 having the magnetic unit 5021, the step S204 is executed. When the hall sensing circuit 5111 detects that the plug unit 502 having the magnetic unit 5021, the step S105 is executed.

In the step S204, the hall sensing circuit 5111 does not detect the magnetic unit 5021. It means the connected microphone is not the special microphone (i.e. a general functional microphone). Thus, the hall sensing circuit 5111 outputs an identify signal to notify the processor of the portable speaker 51 that the connected microphone is a general microphone. The processing procedure for the audio signal having the special function cannot be operated. At present, the processor of the portable speaker 51 executes general microphone process (i.e. receives the microphone signal), so as to play the general microphone signal in the portable speaker 51.

In the step S205, the hall sensing circuit 5111 detects the plug unit 502 having the magnetic unit 5021. It means the connected microphone is the special microphone of the present invention (i.e. the connected microphone, for example, has the special function, such as the voice change, the tone modulation, etc). Thus, the hall sensing circuit 5111 outputs the identify signal to notify the processor of the portable speaker 51 that the connected microphone is the special microphone 50. The processor of the portable speaker 51 receives the special microphone signal. At present, the processor of the portable speaker 51 receives the special microphone signal and executes processing procedure accordingly. Then the sound transmitter of the portable speaker 51 plays the special microphone signal, so as to generate special surrounding effect, such as KTV surrounding effect or concert surrounding effect, etc.

[An Exemplary Embodiment of Transmission System of an Expandable Electronic Device]

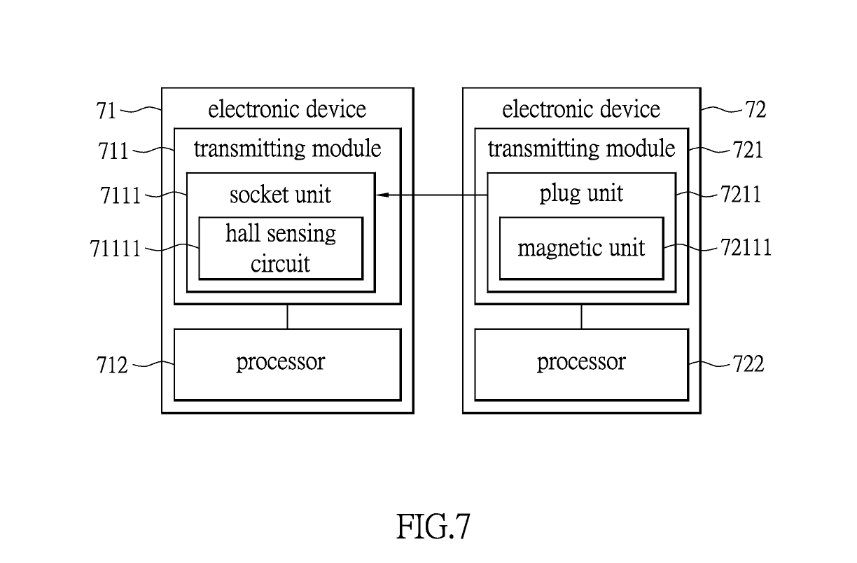

Please refer to FIG. 7. FIG. 7 describes a block diagram of a transmission system of an expandable electronic device according to the exemplary embodiment of the present invention. The transmission system comprises electronic devices 71, 72, wherein the electronic device 71 can be an expandable electronic device. The electronic device 71 has a transmitting module 711 and a processor 712. The electronic device 72 has a transmitting module 712 and a processor 722. The transmitting module 711 has a socket unit 7111. The socket unit 7111 has a hall sensing circuit 71111. The transmitting module 712 has a plug unit 7211. The plug unit 7211 has a magnetic unit 72111. The transmitting module 711 is coupled to the processor 712. The transmitting module 721 is coupled to the processor 722. The plug unit 7211 of the electronic device 72 is used to insert into the plug unit 7111 of the electronic device 71. When the plug unit 7211 is inserted into the socket unit 7111, the hall sensing circuit 71111 of the socket unit 7111 detects the magnetic unit 72111 of the plug unit 7211 to generate the magnetic field sensing signal. Afterward, the processor 712 of the electronic device 71 receives the magnetic field sensing signal to execute the corresponding processing procedure accordingly. Simply, the electronic device 71 can determine that whether the sort of the electronic device 72 is the same as the electronic device 71 or other sorts according to the hall sensing circuit 71111 and the magnetic unit 721111. Then the electronic device 71 determines whether to output the audio signal to the electronic device 72.

The electronic devices 71, 72 can use any wire signal connector to achieve the connection. For example, the transmission line connected between the tablet and the smart phone, the keyboard and the computer host, or the mouse and the computer host, etc. The plug unit and the socket unit are capable to process the identification through the hall sensing circuit 71111 and the magnetic unit 72111. So that the compatible electronic devices can start the special function.

It is worth to note that the connection port of the socket unit 7111 and the plug unit 7211 can be the specification for USB, 2.5 mm audio cable, or 3.5 mm audio cable. The present invention is not limited thereto.

In the exemplary embodiment of the present invention, the expandable electronic device having the hall sensing circuit can connect to the magnetic unit of the other electronic device through the wire method. Then the hall sensing circuit determines that whether the other electronic device is the same sort as the expandable electronic device or other sorts. When the other electronic device is the same as the expandable electronic device, the expandable electronic and the other electronic device execute the signal processing by cooperate method. Through the above identification method, using one expandable electronic device can maintain original function and using many expandable electronic devices can further improve the original function.

In exemplary embodiment of the present invention, the expandable electronic device can connect to the magnetic unit of other electronic devices through the hall sensing circuit and using the wired method, so as to identify whether the sort of the connected other electronic devices is the same as the expandable electronic device. When the other electronic device is the same as the expandable electronic device, all connected expandable electronic devices execute the signal processing by the cooperate method through the processors of each expandable electronic device. Through the above identification method, using one expandable electronic device can maintain original function and using many expandable electronic devices can further improve the original function. In other words, when the user carries one expandable electronic device only, the expandable electronic device can provide the original function. Furthermore, when the user carries many expandable electronic devices, the expandable electronic devices can be connected with each other and can improve the original function through the expandable method.

It is worth to note that the hall sensing circuit of the expandable electronic device has several advantages. For example, the hall sensing circuit has higher sensitivity for the magnetic field, simpler structure, smaller volume, wider frequency response, larger variation of the output voltage, and longer service life, etc. In the situation that the expandable electronic device is must usually be as the portable electronic device, the circuit design does not need to change the original circuit architecture substantially, so as to reach the required effect.

Based the above description, the present disclosure completely complies with the patentability requirements: novelty, non-obviousness, and utility. It will be apparent to those skilled in the art that various modifications and variations can be made to the structure of the invention without departing from the scope or spirit of the invention. In view of the foregoing descriptions, it is intended that the invention covers modifications and variations of this invention if they fall within the scope of the following claims and their equivalents.

What is claimed is:

1. A transmission system of an expandable electronic device, comprising:
a first electronic device, comprising:
a first socket unit, having a first hall sensing circuit; and
a first processor, coupled to the first hall sensing circuit; and
a second electronic device, comprising:
a first plug unit, having a first magnetic unit, wherein the first plug unit is used to insert into the first socket unit so that the second electronic device is electrically connected to the first electronic device; and
a second processor, coupled to the first plug unit;
wherein, when the first plug unit is inserted into the first socket unit, the first magnetic unit is detected by the first hall sensing circuit so as to generate a first magnetic field sensing signal and the first processor executes a first processing procedure according to the first magnetic field sensing signal.

2. The transmission system according to claim 1, wherein the second electronic device further comprises:
a second socket unit, having a second hall sensing circuit coupled to the second processor.

3. The transmission system according to claim 2 further comprising:
a third electronic device, comprising:
a second plug unit, having a second magnetic unit; and
a third processor, coupled to the second plug unit;
wherein, when the second plug unit is inserted into the second socket unit, the second magnetic unit is detected by the second hall sensing circuit so as to generate a second magnetic field sensing signal and the second processor executes a second processing procedure according to the second magnetic field sensing signal.

4. The transmission system according to claim 3, wherein the first processor transmits a result generated by the first processing procedure to the second processor, the second processor executes the second processing procedure according to the result generated by the first processing procedure.

5. The transmission system according to claim 1, wherein the first hall sensing circuit has at least one of sensing modes preset.

6. The transmission system according to claim 5, wherein the first processor executes the first processing procedure according to the sensing mode of the first magnetic unit detected by the first hall sensing circuit.

7. The transmission system according to claim 1, wherein the specification of the first plug unit is USB plug, 2.5 mm plug, or 3.5 mm plug.

8. The transmission system according to claim 1, wherein the first electronic device and the second electronic device are portable speakers.

9. The transmission system according to claim 1, wherein the first electronic device is a portable speaker and the second electronic device is a specific microphone.

10. An expandable electronic device, comprising:
a socket unit, having a hall sensing circuit; and
a processor, coupled to the socket unit;
wherein when the socket unit is inserted into a plug unit of another expandable electronic device, a first magnetic unit of the plug unit of another expandable electronic device is detected by the hall sensing circuit of the socket unit and the processor executes a processing procedure correspondingly.

11. The expandable electronic device according to claim 10, further comprising:
a second socket unit, having a second magnetic unit.

12. The expandable electronic device according to claim 10, wherein the hall sensing circuit has at least one of sensing modes preset.

13. The expandable electronic device according to claim 12, wherein the processor executes the processing procedure according to the sensing mode of the magnetic unit of another expandable electronic device detected by the hall sensing circuit.

14. The expandable electronic device according to claim 10, wherein the specification of the plug unit is USB plug, 2.5 mm plug, or 3.5 mm plug.

15. The expandable electronic device according to claim 10, wherein the expandable electronic device is a portable speaker.

16. The expandable electronic device according to claim 15, wherein another expandable electronic device is a portable speaker.

17. The expandable electronic device according to claim 15, wherein another expandable electronic device is a specific microphone.
